(19) United States
(12) Patent Application Publication
(10) Pub. No.: US 2024/0334237 A1
(43) Pub. Date: Oct. 3, 2024

(54) METHOD AND APPARATUS OF HANDLING PACKET DISCARD FOR EXTENDED REALITY IN WIRELESS NETWORK

(71) Applicant: Samsung Electronics Co., Ltd., Suwon-si (KR)

(72) Inventors: Vinay Kumar SHRIVASTAVA, Bangalore (IN); Sriganesh RAJENDRAN, Bangalore (IN)

(21) Appl. No.: 18/622,681

(22) Filed: Mar. 29, 2024

(30) Foreign Application Priority Data
Mar. 30, 2023 (IN) 202341023943
Mar. 9, 2024 (IN) 202341023943

(51) Int. Cl. H04W 28/02; H04L 67/131; H04W 76/38

(52) U.S. Cl. CPC H04W 28/0268; H04L 67/131; H04W 76/38

(57) ABSTRACT

The disclosure relates to a 5G or 6G communication system for supporting a higher data transmission rate. Embodiments herein is to provide a method for handling packet discard for extended reality in wireless communication network. The method includes receiving a configuration message including information of a first discard timer for low importance, a second discard timer, and a PDU set discard parameter, wherein the first discard timer is set to a value that is shorter than a value of the second discard timer, obtaining at least one packet data convergence protocol (PDCP) service data unit (SDU) from at least one upper layer, and performing, for the at least one PDCP SDU, a transmit operation including a PDCP SDU discard based on the first discard timer, the second discard timer, and the PDU set discard parameter.

### CROSS REFERENCE TO RELATED APPLICATIONS

This application is based on and claims priority under 35 U.S.C. § 119 to Indian Provisional Patent Application No. 202341023943, filed on Mar. 30, 2023, and Indian Complete Patent Application No. 202341023943, filed on Mar. 9, 2024, in the Indian Intellectual Property Office, the disclosures of which are incorporated herein by reference.

### BACKGROUND

### 1. Field

The present disclosure is related to, a telecommunication network. More particularly the present disclosure is related to handling protocol data unit (PDU) set importance while packet discarding for extended reality in wireless communication network.

### 2. Description of Related Art

5^{th} generation (5G) mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

Extended Reality (XR) is an umbrella term for different realities including Virtual Reality (VR), Augmented Reality (AR) and Mixed Reality (MR), and is considered as an essential technology to enable the realization of digital twin/meta universe. XR is incorporated as an agreed work item in 5G Advanced (i.e., 3GPP Release 18), which is targeted to provide a communication system framework that fulfils challenging needs of high data rate, very low latency and power efficient connectivity for XR applications.

Protocol data convergence protocol (PDCP) is a layer-2 sub-layer and is involved in a number of functionalities for the data plane processing of the transmitted and received packets. These functionalities include but not limited to service data unit (SDU) discard, ciphering and integrity protection, header compression on transmitting side and reordering, deciphering and integrity verification, duplicate discarding, header decompression on receiving side. Each radio bearer (RB) is associated with a transmitting PDCP entity and/or a receiving PDCP entity. SDU discard procedure involves discard of the PDCP SDU when the associated timer is expired or the successful delivery of a PDCP SDU is confirmed from peer PDCP entity e.g., through a PDCP status report.

For XR applications, the existing PDCP SDU discard may not be efficient and effective as the XR applications are more tightly coupled with the frame or PDU set transmission, and not with the IP packet transmission which is typically one-to-one mapped to the PDCP SDU. As a result, existing mechanism may lead to an in-efficient SDU discard operation, excessive processing burden and/or transmission resource wastage and so on. Moreover, different frames or PDU sets may have different importance (e.g., need of the PDU sets for decoding other PDU sets) and their discard operation may need differentiated treatment. This aspect is completely lacking in the prior art. Thus, it is desired to address the above-mentioned disadvantages or other shortcomings or at least provide a useful alternative for PDCP discard mechanism for extended reality in the wireless networks.

### SUMMARY

The principal object of the embodiments herein is to provide a method and network apparatus for handling PDU set importance (PSI) while packet discarding for extended reality in wireless communication network.

Yet another object of the embodiments herein is to handle PDCP operations for PSI based SDU discard.

Another object of the embodiments herein is to provide a PSI based discard timer configuration and operation. The PSI based discard timer has shorter value than normal discard timer.

Another object of the embodiments herein is to provide a PSI value configuration from application and PSI value signalling through GTP header.

Another object of the embodiments herein is to handle subsequently received SDUs of the PDU set after the discard timer expiry of the at least one SDU of the PDU set.

Another object of the embodiments herein to provide configuration signaling of PSI based SDU discard parameters per radio bearer.

Another object of the embodiments herein to activate and deactivate for PSI based SDU discard.

Another object of the embodiments herein provides a PDU set based discard configuration parameter per radio bearer.

Another object of the embodiments herein is to enable a PSI based SDU discard mechanism for XR.

Another object of the embodiments herein is to improve the UE and network performance for XR applications.

In one embodiment, the objectives are achieved by providing a method by a user equipment (UE) for handling packet discard for extended reality (XR) in a wireless communication network, comprising receiving configuration message including information of a first discard timer for low importance, a second discard timer, and a PDU set discard parameter, wherein the first discard timer is configured shorter than the second discard timer, obtaining at least one packet data convergence protocol (PDCP) service data unit (SDU) from at least one upper layer, and performing, for the at least one PDCP SDU, a transmit operation including a PDCP SDU discard based on the first discard timer, the second discard timer, and the PDU set discard parameter.

In one example, the objectives are achieved by providing a method by a network apparatus for handling packet discard for extended reality in wireless communication network, comprising transmitting configuration message including information of a first discard timer for low importance, a second discard timer, and a PDU set discard parameter, receiving at least one packet data convergence protocol (PDCP) service data unit (SDU) from a user equipment (UE), identifying that at least one PDCP SDU is discarded by the UE based on the first discard timer, the second discard timer, and the PDU set discard parameter, and transmitting a PDCP status report to confirm the reception of the at least one PDCP SDU to the UE.

In one example, the objectives are achieved by providing a user equipment (UE) for handling packet discard for extended reality (XR) in a wireless communication network, comprising an input/output (I/O) interface, and a packet discard handler communicatively coupled with the I/O interface, wherein the packet discard handler is configured to: receive configuration message including information of a first discard timer for low importance, a second discard timer, and a PDU set discard parameter, wherein the first discard timer is configured shorter than the second discard timer, obtain at least one packet data convergence protocol (PDCP) service data unit (SDU) from at least one upper layer, and perform, for the at least one PDCP SDU, a transmit operation including a PDCP SDU discard based on the first discard timer, the second discard timer, and the PDU set discard parameter.

In one example, the objectives are achieved by providing a network apparatus for handling packet discard for extended reality in wireless communication network, comprising an I/O interface, and a packet discard handler communicatively coupled with the I/O interface, wherein the packet discard handler is configured to: transmit configuration message including information of a first discard timer for low importance, a second discard timer, and a PDU set discard parameter, receive at least one packet data convergence protocol (PDCP) service data unit (SDU) from a user equipment (UE), identify that at least one PDCP SDU is discarded by the UE based on the first discard timer, the second discard timer, and the PDU set discard parameter, and transmit a PDCP status report to confirm the reception of the at least one PDCP SDU to the UE.

In one example, the objectives are achieved by providing a method for handling a PDU set importance (PSI) while packet discarding for extended reality (XR) in wireless communication network. The method includes configuring, by a transmitting PDCP entity, a first discard timer for low importance, a second discard timer, and a PDU set integrated handling indication (PSIHI) represented by PDU set discard parameter configuration based on received XR radio bearer configuration message. Further, the method includes receiving, by the transmitting PDCP entity, at least one PDCP SDU along with PSI value associated with at least one PDU set from at least one upper layer. Further, the method includes determining, by the transmitting PDCP entity, whether the at least one PDCP SDU is a first SDU of the at least one PDU set, and the PDU set discard is configured as TRUE. Further, the method includes starting the first discard timer for low importance, when the at least one PDCP SDU is a first PDCP SDU of the at least one PDU set is received, when the PDCP SDU is associated with a PSI of low importance and when the PDU set discard is configured as TRUE. Also, discarding the at least one PDU set, when the first discard timer for low importance of the at least one PDCP SDU of the at least one PDU set expires or when a PDCP status report is received from the receiving PDCP entity.

Further, the method includes starting the second discard timer, when the at least one PDCP SDU is a first PDCP SDU of the at least one PDU set is received, when the PDCP SDU is associated with a PSI of high importance and when the PDU set discard is configured as TRUE. Also, discarding the at least one PDU set, when the second discard timer of the at least one PDCP SDU of the at least one PDU set expires or when a PDCP status report is received from the receiving PDCP entity. Further, the method includes starting the first discard timer for low importance, when the at least one PDCP SDU is received, when the PDCP SDU is associated with PSI of low importance and when the PDU set discard is configured as FALSE. Also, discarding the at least one PDCP SDU when the first discard timer for low importance expires or when the PDCP status report is received from the receiving PDCP entity.

Further, the method includes starting the second discard timer, when the at least one PDCP SDU is received, when the PDCP SDU is associated with PSI of high importance and when the PDU set discard is configured as FALSE. Also, discarding the at least one PDCP SDU when the second discard expires or when the PDCP status report is received from the receiving PDCP entity.

In an embodiment, the PSI value associated with at least one PDU set is received from at least one upper layers, when the transmitting PDCP entity is at a User Equipment, wherein the upper layer is at least one SDAP layer, application layer or service layer.

In an embodiment, the PSI value associated with at least one PDU set is received from at least one upper layer, in GTP header of the at least one PDCP SDU, when the transmitting PDCP entity is at a network entity, wherein the upper layer is at least one SDAP layer, application layer or service layer.

In an embodiment, the method includes determining, by the transmitting PDCP entity, whether the first discard timer for low importance or the second discard timer is expired for the at least one PDCP SDU associated with a PDU set. Further, the method includes discarding, by the transmitting PDCP entity, the at least one subsequently received PDCP SDU from the upper layer and associated with the PDU set, when the first discard timer for low importance or the second discard timer is already expired for at least one PDCP SDU associated with the PDU set.

In an embodiment, the at least one of the first discard timer for low importance and the second discard timer is configured for the transmitted PDCP entity only for specific Data Radio Bearers (DRBs) providing XR services.

In an embodiment, the duration of the first discard timer for low importance is less than the duration of the second discard timer and is configured in XR radio bearer configuration message by a RRC signaling message.

In an embodiment, the method includes starting, by the transmitting PDCP entity, the first discard timer for low importance upon reception of the PDCP SDU belonging to a low importance PDU set from the upper layer. Further, the method includes starting, by the transmitting PDCP entity, the second discard timer upon reception of the PDCP SDU not belonging to a low importance PDU set from the upper layer.

In an embodiment, the XR radio bearer configuration message comprises the first discard timer for low importance applicable to at least one PSI value associated with the at least one PDU set.

In an embodiment, the method includes receiving, by the transmitting PDCP entity, a request for discard of PDU set from the upper layers. Further, the method includes discarding, by the transmitting PDCP entity, all PDCP SDUs and PDCP PDUs of the at least one PDU set.

In an embodiment, the method includes indicating, by the transmitting PDCP entity, the discard of the PDCP SDUs of the PDU set by setting an indication field in PDCP header of the first PDCP PDU for the next PDU set.

In an embodiment, the method includes indicating to transmitting radio link control (RLC) entity for discarding all the PDCP SDUs or PDUs of the at least one PDU set of low importance when the PDU set discard is configured as TRUE, when the first discard timer for low importance is expired at PDCP and the one or more PDCP SDUs or PDUs belonging to the same PDU set is submitted to RLC. Also, the method includes indicating to the transmitting RLC entity for discarding all the PDCP SDUs or PDUs of the at least one PDU set of high importance when the PDU set discard is configured as TRUE, when the second discard timer is expired at PDCP and the one or more PDCP SDUs or PDUs belonging to the same PDU set is submitted to RLC.

Further, the method includes indicating to the transmitting RLC entity for discarding at least one PDCP SDU or PDU of the at least one PDU set of low importance when the PDU set discard is configured as FALSE, when the first discard timer for low importance is expired at the PDCP layer and the at least one PDCP SDU or PDU belonging to the same PDU set is submitted to RLC layer. Also, the method includes indicating to the transmitting RLC entity for discarding at least one PDCP SDU or PDU of the at least one PDU set of high importance when the PDU set discard is configured as FALSE, when the second discard timer is expired at the PDCP layer and at least one PDCP SDU or PDU belonging to the same PDU set is submitted to RLC layer.

In an embodiment, the method includes discarding by the transmitting RLC entity at least one PDCP SDU or PDU of the at least one PDU set, when a transmitting PDCP entity indicates to the transmitting RLC entity to discard and the at least one PDCP SDU or PDU of the at least one PDU set is not yet transmitted by the transmitting RLC entity. Further, the method includes discarding, by transmitting RLC entity the at least one PDCP SDU or PDU of the at least one PDU set, when a transmitting PDCP entity indicates to the transmitting RLC entity to discard and the at least one PDCP SDU or PDU of the at least one PDU set is already transmitted by the transmitting RLC entity. Also, the method includes skipping, by the transmitting RLC entity, the discard of at least one PDCP SDU or PDU of the at least one PDU set, when a transmitting PDCP entity indicates to the transmitting RLC entity to discard and the at least one PDCP SDU or PDU of the at least one PDU set is already transmitted by the transmitting RLC entity.

In an embodiment, the transmitting PDCP entity is at least one of the UE or the network entity and the receiving PDCP entity is at least one of the UE or the network entity.

In an embodiment, the method includes continuing, by the transmitting PDCP entity, the PDCP SDUs or the PDCP PDUs of the at least one PDU set which is initially assigned a sequence number and discarding the PDCP SDUs or the PDCP PDUs of the at least one PDU set which is not yet assigned a sequence number, upon discarding of the PDCP SDUs or the PDCP PDUs of the at least one PDU set. Further, the method includes assigning, by the transmitting PDCP entity, to the first PDCP SDU of the next PDU set a consecutive sequence number with respect to the last sequence number assigned to the PDCP SDU of the previous PDU set. Further, the method includes indicating, by the transmitting PDCP entity, about discard of the at least one PDCP SDUs or PDCP PDUs of the at least one PDU set using a bit or a bitmap or a field in PDCP header of the next PDU set

In an embodiment, the method includes performing, by the transmitting PDCP entity, a priority mapping of the at least one PDU set pertaining to a quality of service (QoS) flow to a data radio bearer (DRB) based on meta information received from the application layer, based on implementation without a need of configuration from the network, wherein meta information may comprise of a PSI value, a PSI threshold, and a discard threshold.

In an embodiment, the PDCP SDU associated with a PSI for high importance is the PDCP SDU which is not indicated with a PSI for low importance.

In an embodiment, capability to support PSI based discard is indicated in UE capability message.

Accordingly, the embodiment herein is to provide a method for a PDU set importance handling mechanism while packet discarding for extended reality in wireless communication network. The method includes configuring, by a receiving PDCP entity, a PDU set level re-ordering timer, a PDU set level indication for in-sequence delivery, and a PDU set level indication for out of order delivery, and a PDU set integrated handling indication (PSIHI) represented by PDU set discard parameter configuration based on received XR radio bearer configuration message. Further, the method includes receiving, by the receiving PDCP entity, the at least one SDU of the at least one PDU set from the transmitting PDCP entity. Further, the method includes starting, by the receiving PDCP entity, the PDU set level re-ordering timer when the at least one SDU of the at least one PDU set is received from the transmitting PDCP entity. Also, the method includes discarding, by the receiving PDCP entity, the received PDCP PDUs of the at least one PDU set of lower importance, when the PDU set level re-ordering timer expires. Further, the method includes transmitting, by the receiving PDCP entity, a PDCP status report to confirm the reception of the at least one PDCP SDU of the PDU set to the transmitting PDCP entity. Further, the method includes transmitting, by the receiving PDCP entity, received PDUs of the at least one PDU set with higher importance to the upper layers.

In an embodiment, the PSI value comprises at least one of a set of values, a range of values, a field, a flag, a bit, a bitmap or an index.

In an embodiment, the method includes receiving, by the receiving PDCP entity, an indication for the discard of the at least one PDCP SDUs and the at least one PDCP PDUs of the at least one PDU set indicated in the indication field of the PDCP header of the first PDCP PDU for the next PDU set. Further, the method includes discarding, by the receiving PDCP entity, the received PDCP SDUs of the incompletely received at least one PDU set; and continuing processing with next PDU set.

In one example, the objectives are achieved by providing a transmitting PDCP entity for handling a PDU set importance (PSI) while packet discarding for extended reality (XR) in wireless communication network. The transmitting PDCP entity comprises a processor and a packet discard handler communicatively coupled to the processor. The packet discard handler configures a first discard timer for low importance, a second discard timer, and a PDU set integrated handling indication (PSIHI) represented by PDU set discard parameter configuration based on received XR radio bearer configuration message.

Further, receives at least one PDCP SDU along with PSI value associated with at least one PDU set from at least one upper layer. Further, determines whether the at least one PDCP SDU is a first SDU of the at least one PDU set, and the PDU set discard is configured as TRUE. Also, starts the first discard timer for low importance, when the at least one PDCP SDU is a first PDCP SDU of the at least one PDU set is received, when the PDCP SDU is associated with a PSI of low importance and when the PDU set discard is configured as TRUE. Further, discard the at least one PDU set, when the first discard timer for low importance of the at least one PDCP SDU of the at least one PDU set expires or when a PDCP status report is received from the receiving PDCP entity. Also, the packet discard handler start the second discard timer, when the at least one PDCP SDU is a first PDCP SDU of the at least one PDU set is received, when the PDCP SDU is associated with a PSI of high importance and when the PDU set discard is configured as TRUE.

Further, discards the at least one PDU set, when the second discard timer of the at least one PDCP SDU of the at least one PDU set expires or when a PDCP status report is received from the receiving PDCP entity. Also, the packet discard handler starts the first discard timer for low importance, when the at least one PDCP SDU is received, when the PDCP SDU is associated with PSI of low importance and when the PDU set discard is configured as FALSE. Further, discard the at least one PDCP SDU when the first discard timer for low importance expires or when the PDCP status report is received from the receiving PDCP entity. Also, the packet discard handler starts the second discard timer, when the at least one PDCP SDU is received, when the PDCP SDU is associated with PSI of high importance and when the PDU set discard is configured as FALSE. Further, discards the at least one PDCP SDU when the second discard expires or when the PDCP status report is received from the receiving PDCP entity.

In one example, the objectives are achieved by providing a receiving PDCP entity for a PDU set importance handling mechanism while packet discarding for extended reality in wireless communication network. The receiving PDCP entity comprises a processor and a packet discard handler communicatively coupled to the processor. The packet discard handler configures a PDU set level re-ordering timer, a PDU set level indication for in-sequence delivery, and a PDU set level indication for out of order delivery, and a PDU set integrated handling indication (PSIHI) represented by PDU set discard parameter configuration based on received XR radio bearer configuration message. Further the packet discard handler receives the at least one SDU of the at least one PDU set from the transmitting PDCP entity (200). Further, starts the PDU set level re-ordering timer when the at least one SDU of the at least one PDU set is received from the transmitting PDCP entity.

Further, the packet discard handler discards the received PDCP PDUs of the at least one PDU set of lower importance, when the PDU set level re-ordering timer expires. Further, the packet discard handler transmits a PDCP status report to confirm the reception of the at least one PDCP SDU of the PDU set to the transmitting PDCP entity. Further, the packet discard handler transmits received PDUs of the at least one PDU set with higher importance to the upper layers.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications be made within the scope of the embodiments herein.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

These and other features, aspects, and advantages of the present embodiments are illustrated in the accompanying drawings, throughout which like reference letters indicate corresponding parts in the various figures. The embodiments herein will be better understood from the following description with reference to the drawings, in which:

FIG. 1 illustrates a system architecture for handling PDU set importance while packet discarding for extended reality in wireless communication network according to the embodiment of the present disclosure;

FIG. 2A illustrates a transmitting PDCP entity for handling PDU set importance while packet discarding for extended reality in wireless communication network according to the embodiment of the present disclosure;

FIG. 2B illustrates a receiving PDCP entity for handling PDU set importance while packet discarding for extended reality in wireless communication network according to the embodiment of the present disclosure;

FIG. 3 illustrates a flow diagram of a method for handling PDU set importance while packet discarding for extended reality in wireless communication network by a transmitting PDCP entity according to the embodiment of the present disclosure; and

FIG. 4 illustrates a flow diagram of a method for handling PDU set importance while packet discarding for extended reality in wireless communication network by a receiving PDCP entity according to the embodiment of the present disclosure.

It may be noted that to the extent possible, like reference numerals have been used to represent like elements in the drawing. Further, those of ordinary skill in the art will appreciate that elements in the drawing are illustrated for simplicity and may not have been necessarily drawn to scale. For example, the dimension of some of the elements in the drawing may be exaggerated relative to other elements to help to improve the understanding of aspects of the disclosure. Furthermore, the elements may have been represented in the drawing by conventional symbols, and the drawings may show only those specific details that are pertinent to the understanding the embodiments of the disclosure so as not to obscure the drawing with details that will be readily apparent to those of ordinary skill in the art having benefit of the description herein.

### DETAILED DESCRIPTION

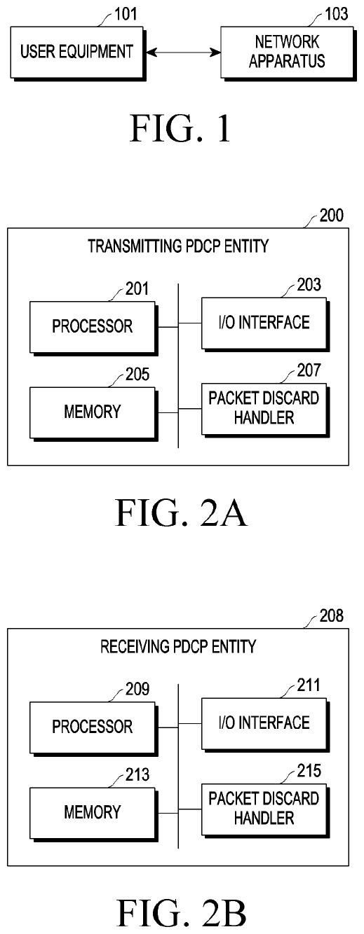

FIGS. 1 through 4, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments are described and illustrated in terms of blocks that carry out a described function or functions. These blocks, which referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and optionally be driven by firmware and software. The circuits, for example, be embodied in one or more semiconductor chips, or on substrate supports such as printed circuit boards and the like. The circuits constituting a block be implemented by dedicated hardware, or by a processor (e.g., one or more programmed microprocessors and associated circuitry), or by a combination of dedicated hardware to perform some functions of the block and a processor to perform other functions of the block. Each block of the embodiments be physically separated into two or more interacting and discrete blocks without departing from the scope of the provided method. Likewise, the blocks of the embodiments be physically combined into more complex blocks without departing from the scope of the provided method.

The accompanying drawings are used to help easily understand various technical features and it is understood that the embodiments presented herein are not limited by the accompanying drawings. As such, the provided method is construed to extend to any alterations, equivalents and substitutes in addition to those which are particularly set out in the accompanying drawings. Although the terms first, second, etc. used herein to describe various elements, these elements should not be limited by these terms. These terms are generally used to distinguish one element from another.

Accordingly, the embodiments disclose a method for handling a PDU set importance (PSI) while packet discarding for extended reality (XR) in wireless communication network. The method includes configuring, by a transmitting PDCP entity, a first discard timer for low importance, a second discard timer, and a PDU set integrated handling indication (PSIHI) represented by PDU set discard parameter configuration based on received XR radio bearer configuration message. Further, the method includes receiving, by the transmitting PDCP entity, at least one PDCP SDU along with PSI value associated with at least one PDU set from at least one upper layer.

Further, the method includes determining, by the transmitting PDCP entity, whether the at least one PDCP SDU is a first SDU of the at least one PDU set, and the PDU set discard is configured as TRUE. Further, the method includes starting the first discard timer for low importance, when the at least one PDCP SDU is a first PDCP SDU of the at least one PDU set is received, when the PDCP SDU is associated with a PSI of low importance and when the PDU set discard is configured as TRUE. Also, discarding the at least one PDU set, when the first discard timer for low importance of the at least one PDCP SDU of the at least one PDU set expires or when a PDCP status report is received from the receiving PDCP entity. Further, the method includes starting the second discard timer, when the at least one PDCP SDU is a first PDCP SDU of the at least one PDU set is received, when the PDCP SDU is associated with a PSI of high importance and when the PDU set discard is configured as TRUE.

Also, discarding the at least one PDU set, when the second discard timer of the at least one PDCP SDU of the at least one PDU set expires or when a PDCP status report is received from the receiving PDCP entity. Further, the method includes starting the first discard timer for low importance, when the at least one PDCP SDU is received, when the PDCP SDU is associated with PSI of low importance and when the PDU set discard is configured as FALSE. Also, discarding the at least one PDCP SDU when the first discard timer for low importance expires or when the PDCP status report is received from the receiving PDCP entity. Further, the method includes starting the second discard timer, when the at least one PDCP SDU is received, when the PDCP SDU is associated with PSI of high importance and when the PDU set discard is configured as FALSE. Also, discarding the at least one PDCP SDU when the second discard expires or when the PDCP status report is received from the receiving PDCP entity.

Accordingly, the embodiment herein is to provide a method for a PDU set importance handling mechanism while packet discarding for extended reality in wireless communication network. The method includes configuring, by a receiving PDCP entity, a PDU set level re-ordering timer, a PDU set level indication for in-sequence delivery, and a PDU set level indication for out of order delivery, and a PDU set integrated handling indication (PSIHI) represented by PDU set discard parameter configuration based on received XR radio bearer configuration message. Further, the method includes receiving, by the receiving PDCP entity, the at least one SDU of the at least one PDU set from the transmitting PDCP entity. Further, the method includes starting, by the receiving PDCP entity, the PDU set level re-ordering timer when the at least one SDU of the at least one PDU set is received from the transmitting PDCP entity.

Also, the method includes discarding, by the receiving PDCP entity, the received PDCP PDUs of the at least one PDU set of lower importance, when the PDU set level re-ordering timer expires. Further, the method includes transmitting, by the receiving PDCP entity, a PDCP status report to confirm the reception of the at least one PDCP SDU of the PDU set to the transmitting PDCP entity. Further, the method includes transmitting, by the receiving PDCP entity, received PDUs of the at least one PDU set with higher importance to the upper layers.

Accordingly, the embodiments disclose a transmitting PDCP entity for handling a PDU set importance (PSI) while packet discarding for extended reality (XR) in wireless communication network. The transmitting PDCP entity comprises a processor and a packet discard handler communicatively coupled to the processor. The packet discard handler configure a first discard timer for low importance, a second discard timer, and a PDU set integrated handling indication (PSIHI) represented by PDU set discard parameter configuration based on received XR radio bearer configuration message. Further, receives at least one PDCP SDU along with PSI value associated with at least one PDU set from at least one upper layer. Further, determines whether the at least one PDCP SDU is a first SDU of the at least one PDU set, and the PDU set discard is configured as TRUE. Also, starts the first discard timer for low importance, when the at least one PDCP SDU is a first PDCP SDU of the at least one PDU set is received, when the PDCP SDU is associated with a PSI of low importance and when the PDU set discard is configured as TRUE.

Further, discard the at least one PDU set, when the first discard timer for low importance of the at least one PDCP SDU of the at least one PDU set expires or when a PDCP status report is received from the receiving PDCP entity. Also, the packet discard handler start the second discard timer, when the at least one PDCP SDU is a first PDCP SDU of the at least one PDU set is received, when the PDCP SDU is associated with a PSI of high importance and when the PDU set discard is configured as TRUE. Further, discards the at least one PDU set, when the second discard timer of the at least one PDCP SDU of the at least one PDU set expires or when a PDCP status report is received from the receiving PDCP entity. Also, the packet discard handler starts the first discard timer for low importance, when the at least one PDCP SDU is received, when the PDCP SDU is associated with PSI of low importance and when the PDU set discard is configured as FALSE.

Further, discard the at least one PDCP SDU when the first discard timer for low importance expires or when the PDCP status report is received from the receiving PDCP entity. Also, the packet discard handler starts the second discard timer, when the at least one PDCP SDU is received, when the PDCP SDU is associated with PSI of high importance and when the PDU set discard is configured as FALSE. Further, discards the at least one PDCP SDU when the second discard expires or when the PDCP status report is received from the receiving PDCP entity.

Accordingly, the embodiments disclose a receiving PDCP entity for a PDU set importance handling mechanism while packet discarding for extended reality in wireless communication network. The receiving PDCP entity comprises a processor and a packet discard handler communicatively coupled to the processor. The packet discard handler configures a PDU set level re-ordering timer, a PDU set level indication for in-sequence delivery, and a PDU set level indication for out of order delivery, and a PDU set integrated handling indication (PSIHI) represented by PDU set discard parameter configuration based on received XR radio bearer configuration message. Further the packet discard handler receives the at least one SDU of the at least one PDU set from the transmitting PDCP entity.

Further, starts the PDU set level re-ordering timer when the at least one SDU of the at least one PDU set is received from the transmitting PDCP entity. Further, the packet discard handler discards the received PDCP PDUs of the at least one PDU set of lower importance, when the PDU set level re-ordering timer expires. Further, the packet discard handler transmits a PDCP status report to confirm the reception of the at least one PDCP SDU of the PDU set to the transmitting PDCP entity. Further, the packet discard handler transmits received PDUs of the at least one PDU set with higher importance to the upper layers.

Thus, the provided solution enables efficient approach for PSI based discard mechanism for XR. Also, the provided solution improves the UE and network performance for XR applications.

FIG. 1 illustrates a system architecture for handling PDU set importance while packet discarding for extended reality in wireless communication network according to the embodiment of the present disclosure. The FIG. 1 depicts a wireless communication network that comprises a user equipment (101) and a network apparatus (103). The UE (101) and the network apparatus (103) communicates with each other to handle the PSI based packet discarding for XR applications. The UE (101) can be any end-user device that connects to the network apparatus (103) to access network services, including but not limited to laptop, a palmtop, a desktop, a mobile phone, a smart phone, Personal Digital Assistant (PDA), a tablet, a wearable device, an Internet of Things (IoT) device, a virtual reality device, a television, a connected car, a foldable device, a flexible device, a display device and an immersive system. Also, the network apparatus (103) is a device that creates, manages, and facilitates communication within the telecommunication network.

The telecommunication network is a system of interconnected communication devices and infrastructure that allows information to be exchanged over long distances. The telecommunication network can be classified into local area network, wide area network, metropolitan area network and the like. In some embodiments, the telecommunication network can be a wireless communication network that can be classified into Long Term Evaluation (LTE), 4G, 5G, and 6G. For example, the network apparatus (103) can be but not limited to base stations, transceivers, servers, gateways, and access points. The UE (101) and the network apparatus (103) comprises a packet data convergence protocol (PDCP) entity, a radio link control (RLC) entity, and medium access control (MAC) entity. The PDCP entity at the UE (101) or at the network apparatus (103) performing the transmission function can be a transmitting PDCP entity. Similarly, the PDCP entity at the UE (101) performing the reception PDCP entity can behave as the receiving PDCP entity. Also, the RLC entity at the UE (101) or at the network apparatus can performing a transmission function can be a transmitting RLC entity, and also performing a receiving function can be a receiving RLC entity.

The UE (101) sends a UE capability message to the network apparatus (103) for indicating the capability to support the PSI based discard. Accordingly, this enables the network apparatus to configure the UE for the PSI based discard. Also, the network apparatus (103) transmits a XR radio bearer configuration message to the UE (101) for configuring with a first discard timer for low importance, a second discard timer, and a PDU set integrated handling indication (PSIHI) represented by PDU set discard parameter configuration.

The RRC layer in the UE (101) may provide the received a first discard timer for low importance, a second discard timer, and a PDU set integrated handling indication (PSIHI) represented by PDU set discard parameter configuration to the PDCP entity associated with the UE (101). The PDCP entity may use the received a first discard timer for low importance, the second discard timer, and the PDU set integrated handling indication (PSIHI) represented by PDU set discard parameter configuration for handling the PDU set importance (PSI) while packet discarding.

Similarly, the UE (101) may receive a PDU set level re-ordering timer, a PDU set level indication for in-sequence delivery, and a PDU set level indication for out of order delivery and the PDU set integrated handling indication (PSIHI) represented by PDU set discard parameter configuration from the network apparatus (103). Further, the RRC layer in the UE (101) may provide the received information to the PDCP entity associated with the UE (101).

FIG. 2A illustrates a transmitting PDCP entity for handling PDU set importance while packet discarding for extended reality in wireless communication network according to the embodiment of the present disclosure. The transmitting PDCP entity (200) comprises several components, including a processor (201), an I/O interface (203), a memory (205), and a packet discard handler (207).

The processor (201) of the transmitting PDCP entity (200) communicates with the memory (205), the I/O interface (203), and the packet discard handler (207), executing instructions stored in the memory (205) and performing various processes. It may consist of one or multiple processors, such as a general-purpose CPU (central processing unit), an AP (application processor), a GPU (graphic processing unit), a VPU (vision processing unit), and/or an AI (artificial intelligence)-dedicated NPU (neural processing unit).

The memory (205) of the transmitting PDCP entity (200) includes storage locations to be addressable through the processor (201). The memory (205) may store at least one of PSI values received from upper layer of the transmitting PDCP entity (200), PDCP SDUs of PDU sets received from the network apparatus (103), and XR radio bearer configuration message received from the network apparatus (103). The memory (205) is not limited to a volatile memory and/or a non-volatile memory. Further, the memory (205) may include one or more computer-readable storage media. The memory (205) may include non-volatile storage elements. For example, non-volatile storage elements can include magnetic hard discs, optical discs, floppy discs, flash memories, or forms of electrically programmable memories (EPROM) or electrically erasable and programmable (EEPROM) memories. The memory (205) can store the media streams such as audios stream, video streams, haptic feedbacks and the like.

The I/O interface (203) transmits the information between the memory (205) and external peripheral devices. The peripheral devices are the input-output devices associated with the transmitting PDCP entity (200). The I/O interface (203) receives configuration from the network apparatus (103) associated in the wireless communication network. The I/O interface (203) can receive the PSI values associated with the PDCP SDUs or the PDU set from the upper layers. Also, the I/O interface (203) receives and transmits the signaling messages from/to the network apparatus (103). The signaling messages can include but not limited to PDCP configuration message, and XR radio bearer configuration message.

The packet discard handler (207) of transmitting PDCP entity (200) communicates with the I/O interface (203) and memory (205) for handling a PDU set importance while packet discarding for extended reality in wireless communication network. The packet discard handler (207) is an innovative hardware that is realized through the physical implementation of both analog and digital circuits, including logic gates, integrated circuits, microprocessors, microcontrollers, memory circuits, passive and active electronic components, as well as optical components.

The packet discard handler (207) configures at least one of a first discard timer for low importance, a second discard timer, and a PDU set integrated handling indication (PSIHI) represented by PDU set discard parameter configuration based on received XR radio bearer configuration message. The XR radio bearer configuration message can be received at the transmitting PDCP entity from upper layers.

The packet discard handler (207) receives at least one PDCP SDU along with PSI value associated with at least one PDU set from at least one upper layer. The packet discard handler (207) determines whether the at least one PDCP SDU is a first SDU of the at least one PDU set and/or the PDU set discard is configured as TRUE. The packet discard handler (207) starts the first discard timer for low importance, when the at least one PDCP SDU is a first PDCP SDU of the at least one PDU set is received, when the PDCP SDU is associated with a PSI of low importance, and/or when the PDU set discard is configured as TRUE. The packet discard handler (207) discards the at least one PDU set, when the first discard timer for low importance of the at least one PDCP SDU of the at least one PDU set expires or when a PDCP status report is received from the receiving PDCP entity.

The packet discard handler (207) starts the second discard timer, when the at least one PDCP SDU is a first PDCP SDU of the at least one PDU set is received, when the PDCP SDU is associated with a PSI of high importance, and/or when the PDU set discard is configured as TRUE. The packet discard handler (207) discards the at least one PDU set, when the second discard timer of the at least one PDCP SDU of the at least one PDU set expires or when a PDCP status report is received from the receiving PDCP entity.

The packet discard handler (207) starts the first discard timer for low importance, when the at least one PDCP SDU is received, when the PDCP SDU is associated with PSI of low importance, and/or when the PDU set discard is configured as FALSE. The packet discard handler (207) discards the at least one PDCP SDU when the first discard timer for low importance expires or when the PDCP status report is received from the receiving PDCP entity. The packet discard handler (207) starts the second discard timer, when the at least one PDCP SDU is received, when the PDCP SDU is associated with PSI of high importance, and/or when the PDU set discard is configured as FALSE. The packet discard handler (207) discards the at least one PDCP SDU when the second discard expires or when the PDCP status report is received from the receiving PDCP entity.

In an embodiment, the transmitting PDCP entity (200) of the UE (101) is provided with PDU set importance (PSI) value for at least one PDU set in the uplink direction by the upper layer. For example, the upper layer can include but not limited to a service data adaption protocol (SDAP) layer, an application layer and a service layer. The PSI value can be a set of values, a range of values, a field, a flag, a bit, a bitmap or an index. In an embodiment, the PSI may be provided or informed along with PDU set or is provided as an in-band signaling (e.g., in a header field) in at least one SDU or PDU of the PDU set (e.g., first SDU/PDU of the PDU set).

In an embodiment, the transmitting PDCP entity (200) of the network apparatus (103) (e.g., RAN or gNB) is provided with PDU set importance (PSI) value for at least one PDU set in the downlink direction by the higher layer (e.g., SDAP layer) or the application layer or the service layer or is indicated in the general packet radio service (GPRS) tunneling protocol (GTP) packet received from the core network (CN). The PSI value may be a set of values, a range of values, a field, a flag, a bit, a bitmap or an index. In an embodiment, the PSI may be provided or informed along with PDU set or is provided as an in-band signaling (e.g., in a header field of the GTP PDU) in at least one SDU/PDU of the PDU set (e.g., first SDU/PDU of the PDU set).

In an embodiment, the PSI may be informed to the peer entity (e.g., network (103) to the UE (101) or UE (101) to the network (103)) by adding the PSI value in a header field) in at least one PDCP SDU/PDU of the PDU set (e.g., first SDU/PDU of the PDU set).

In an embodiment, the transmitting PDCP entity (200) is configured with multiple discard timer values for different PSI values for the PDU sets and starts the respective timer with the appropriate discard timer value based on the PSI of the PDU set received from the higher layer and is associated with.

In an embodiment, a higher value of discard timer is configured for a higher PSI value (more importance) for the PDU set. When the first discard timer for the PDU set with a lower PSI value (lower importance) is expired, the SDUs of the relevant PDU set (with lower PSI value) are discarded, however, the SDUs of the PDU set(s) (with higher PSI value(s)) are not discarded if the respective first discard timer(s) for low importance is/are still running.

In an embodiment, a lower value of first discard timer for low importance is configured for a higher PSI value (more importance) for the PDU set.

In an embodiment, only one value of discard timer is configured for the PDU set(s) with lower importance (i.e., lower PSI value) and the PDU set(s) with higher importance (i.e., higher PSI values), however, when the second discard timer is expired for the PDU set with lower PSI, the SDUs of the respective PDU set are discarded. However, when the discard timer is expired for the PDU set with higher PSI value, the SDU of the PDU set are not discarded and are still considered for transmission, given their higher importance.

In an embodiment, the transmitting PDCP entity (200) is configured with and/or utilizes a single timer (e.g., the first discardTimer or a XRdiscardTimer) for a PDU set when the relevant QoS flow is configured with a PDU set integrated handling indication (PSIHI) set as TRUE. Otherwise, if the PSIHI for the QoS flow is set as FALSE, the transmitting PDCP entity (200) is configured with and/or utilizes a legacy timer (e.g., the second discardTimer) for each SDU of the PDU set for the relevant QoS flow. The upper layer may indicate the PSIHI for the QoS flow to the PDCP entity associated with the QoS flow.

In an embodiment, the second discardTimer (used for per SDU discard) when configured for the XR radio bearers may act as a first discardTimer. In an embodiment, the second discardTimer acts as a PDU set based discard timer rather than a SDU discard timer for XR radio bearers. In an embodiment, one or more values for the second discardTimer are configured for different values of the PSI for the PDU sets.

In an embodiment, when upper layers request PDCP discard for XR (i.e., a PDU set discard is requested), the transmitting PDCP entity (200) may discard all stored PDCP SDUs and PDCP PDUs pertaining to the PDU set. In an alternative embodiment, when upper layers request PDCP discard for XR, the transmitting PDCP entity may discard all stored PDCP SDUs and PDCP PDUs.

In an embodiment, the PSI value for the PDU set is only utilized based on the congestion status e.g., when the transmitting PDCP entity (200) determines a congestion situation or the UE (101) is informed or signaled by the network for a congestion situation in a broadcast signaling message like system information block or a dedicated signaling message like a RRC message, a MAC control element or a downlink control information, DCI signaling.

In an embodiment, a PSI value for the PDU set is utilized irrespective of the congestion status (i.e., regardless of whether the transmitting PDCP entity (200) determines a congestion situation or not, or regardless of whether the UE (101) is informed or signaled by the network or not for a congestion situation).

In an embodiment, the PDU set based QoS parameters may be same for all PDU sets within a QoS flow but multiple QoS flows may be mapped to a single DRB. In an embodiment, the transmitting PDCP entity (200) is configured and/or signaled by the network apparatus (103) with the PDU set based parameters per QoS flow mapped to that DRB. The DRB may be configured with at least one of a XR specific discard timer per QoS flow, a discard threshold per QoS, a ongestion timer per QoS flow, a PSIHI parameter 30 per QoS flow, or a PSI range per QoS flow.

In an embodiment, the DRB is configured with a threshold value of PSI value per QoS flow mapped to the DRB and/or a common PSI level for all QoS flows mapped to that DRB, below which the transmitting PDCP entity (200) may need to perform PDU set discard when congestion is detected/notified to the transmitting PDCP entity (200).

In an embodiment, when the transmitting PDCP entity (200), the DRB is configured with a PSI to common priority level mapping rule which is used to convert the PSI values of PDU sets belonging to different QoS flows mapped to that DRB to a common priority level. In an embodiment, this common priority level is used by the DRB to perform PDU set based discard during congestion.

In another embodiment, the priority mapping of PDU sets is done based on UE (101) implementation and does not require configuration from the network. This can be done based on the inputs from the application layer such as the meta 20 information tagged with the packet from the encoder etc.

In an embodiment, the transmitting PDCP entity (200) is configured and/or signaled by the network apparatus (103) for PDU set based SDU discard and/or indication whether or not to discard the entire PDU set if one or more SDUs constituting the PDU set is discarded (e.g., upon expiry of discardTimer or XRdiscardTimer). Alternatively, the network apparatus (103) may configure at least one of a threshold (e.g., number of or percentage of constituent SDUs of the PDU set, if discarded, may lead the transmitting PDCP entity (200) to discard the entire PDU set), a congestion condition applicability (e.g., if the congestion condition determination or signaling is applicable for discarding the PDU set) and a PSIHI (e.g., if the DRB is applicable for PDU set based discarding).

When one or more PDCP SDU(s) pertaining to the PDU set which is discarded, are already associated with PDCP sequence number(s) (SN(s)), there may be SN gap in the transmitted PDCP PDUs and this may cause an increase in PDCP reordering delay in the receiving PDCP entity.

In an embodiment, in order to overcome the aforementioned increased reordering delay issue, the transmitting PDCP entity (200) continues with the already SN assigned PDCP data PDU(s) for the PDU set but still discard the PDCP SDU(s) for the PDU set which are not assigned SN. Further, the first PDCP SDU of the next PDU set is assigned the next in-sequence SN which is yet to be assigned. At the receiving PDCP entity, in order to know that there is a discard of PDCP SDUs of a PDU set and still PDCP SN are in sequence (i.e., without any SN gap), PDCP header of the first PDCP PDU for the next PDU set carries an indication field or a bit or a bitmap to indicate an earlier PDU set discard.

The receiving PDCP entity may discard or remove the received PDCP SDUs of the incompletely received XR PDU set and continue processing with the next XR PDU set. In an embodiment, the number of discarded XR PDU set(s) may be one or more at the transmitting PDCP entity and correspondingly, at the network apparatus (103) while reordering.

In an embodiment, when a PDU belonging to a PDU set, pertaining to a DRB for which PSIHI is configured as TRUE, for which discard timer is expired at the PDCP entity and if one or more other PDCP PDUs belonging to that same PDU set was submitted to an RLC entity, the PDCP entity indicates to the RLC entity to discard all the PDUs belonging to that PDU set.

In an embodiment, the RLC entity may not discard the PDU for which discard is indicated by the PDCP entity, if the packet is already transmitted.

In an embodiment, the RLC entity may discard the PDU for which discard is indicated by the PDCP entity, if the packet is not yet transmitted. In an embodiment, the RLC entity may discard the PDU for which discard is indicated by the PDCP entity, irrespective of whether the packet is already transmitted or not yet transmitted. In an embodiment, the RLC entity may ensures that there is no gap in RLC SN due to PDU set based discard at the RLC entity.

In an embodiment, when a PDU belonging to a PDU set, pertaining to a DRB for which PSIHI is configured as FALSE, for which discard timer is expired at the PDCP entity and if one or more other PDCP PDUs belonging to that same PDU set was submitted to the RLC entity, the transmitting PDCP entity (200) does not indicate to the RLC entity to discard one or more other PDUs belonging to that PDU set.

In an embodiment, the transmitting PDCP entity (200) may indicate to the RLC entity to discard the PDU for which discard timer is expired at the PDCP entity. In an embodiment, the RLC entity may not discard the PDU for which discard is indicated by the transmitting PDCP entity (200), if the packet is already transmitted. In an embodiment, the RLC entity may discard the PDU for which discard is indicated by the transmitting PDCP entity (200), if the packet is not yet transmitted. In an embodiment, the RLC entity may discard the PDU for which discard is indicated by transmitting PDCP entity (200), irrespective of whether the packet is already transmitted or not yet transmitted. In an embodiment, the RLC entity may ensure that there is no gap in RLC SN due to PDU set based discard at the RLC entity.

In an embodiment, when a PDU belonging to a PDU set with a higher value of PSI, pertaining to a DRB for which PSIHI is configured as TRUE and the congestion status is TRUE, for which discard timer is expired at PDCP and if one or more other PDCP PDUs belonging to that same PDU set was submitted to RLC, PDCP may not indicate to RLC to discard the PDUs belonging to that PDU set.

In an embodiment, when a PDU belonging to a PDU set with a lower value of PSI, pertaining to a DRB for which PSIHI is configured as TRUE and the congestion status is TRUE, for which discard timer is expired at PDCP and if one or more other PDCP PDUs belonging to that same PDU set was submitted to RLC, PDCP may indicate to RLC to discard the PDUs belonging to that PDU set.

In an embodiment, the receiving PDCP entity may be configured with a PDU set level re-ordering timer and on the expiry of PDU set level reordering timer, all the SDUs belonging to the incompletely received PDU set are either discarded or delivered to the upper layer. In an embodiment, the received PDUs of the incompletely received PDU set with lower value of PSI are discarded. In an embodiment, the received PDUs of the incompletely received PDU set with higher value of PSI are not discarded, and/or are delivered to upper layer.

In an embodiment, the first discardTimer for the PDU set with relevant PSI (if configured) is started when the transmitting PDCP entity receives the first PDCP SDU (i.e., an IP packet) that is constituting the PDU set, from the upper layer(s). Further, when the following PDCP SDU(s) that is constituting the PDU set (i.e., second, third . . . ) are received, operation of the first discardTimer for the PDU set with relevant PSI is not affected (i.e., timer keeps running). Further, the following PDCP SDU(s) that is constituting the PDU set are linked with the same first discardTimer for the PDU set with relevant PSI (if configured).

In an embodiment, if the first discardTimer for the PDU set with an associated PSI is already expired and subsequently, the transmitting PDCP entity (200) receives further PDCP SDU(s) (i.e., IP packet(s)) from upper layer, the transmitting PDCP entity discards these received PDCP SDU(s) and does not store them in its buffer or transmit them.

In an embodiment, PDCP duplication is employed for XR. Further, PDCP duplication is configured and/or utilized selectively for the one or more PDU sets with different PSI values pertaining to the same XR service. Further, for XR RBs, the transmitting PDCP entity (200), when configured (or deconfigured) with pdcp-duplication, activates (or deactivates) the PDCP duplication for XR RB from the first PDCP SDU of the PDU set. In an embodiment, the transmitting PDCP entity (200) may be configured with PDU sets with different PSI values for which the selective duplication is applied for. In an embodiment, the PDCP duplication is selectively applied for at least one of the higher values of the PSI that is configured or informed or signaled for the PDU sets of the DRB.

TABLE 1 shows a sample description of changes introduced in transmitting PDCP entity (200) operation to support selective duplication.

TABLE 1
Description of changes

```
When submitting a PDCP PDU to lower layer, the UE (101) may:
  - if the transmitting PDCP entity is associated with one RLC entity:
      - submit the PDCP PDU to the associated RLC entity;
  - else, if the transmitting PDCP entity is associated with at least two RLC entities:
    - if the PDCP duplication is activated for the RB:
      - if the PDCP PDU is a PDCP Data PDU:
        - if PDCP entity is associated with a XR Bearer with PDU sets with different
PSI values and selective duplication is configured:
          - if the PDCP Data PDU corresponds to PDU set with higher value of PSI
and is configured for duplication:,
            - duplicate the PDCP Data PDU and submit the PDCP Data PDU to the
associated RLC entities activated for PDCP duplication;
          - else
            - duplicate the PDCP Data PDU and submit the PDCP Data PDU to the
associated RLC entities activated for PDCP duplication;
        - else:
          - submit the PDCP Control PDU to the primary RLC entity.
```

In an embodiment, PDCP routing is employed for XR. Further, routing at PDCP is configured and/or utilized selectively for the one or more PDU sets with different PSI values pertaining to the same XR service. PDCP Routing involves mapping of PDCP PDUs to different RLC legs/logical channels based on PSI value of the PDU set to which the PDCP PDU belongs. In an embodiment, differential treatment may be applied to the RLC legs/Logical channels pertaining to the PDU sets with different PSI values. For example, this differential treatment may comprise of Logical Channel Prioritization (LCP) (for instance, a higher logical channel priority is given to a logical channel pertaining to PDU set(s) with higher PSI value), buffer status reporting and scheduling request (SR) transmission at MAC layer, packet discard at RLC layer and so on.

In an embodiment, the UE (101) indicates the UE capability to support PSI based PDCP discard support (e.g., represented by psi-BasedDiscard parameter) for XR as one or more field, bit, bitmap, feature, flag to the network in one of a UE capability information message, a UE assistance information message, a RRC setup complete, a RRC resume complete or any other RRC message or a NAS message.

TABLE 2 shows a sample description of changes introduced in transmitting PDCP entity (200) operation to support PSI based routing.

TABLE 2
Description of changes

```
When submitting a PDCP PDU to lower layer, the transmitting PDCP entity may:
  - if the transmitting PDCP entity is associated with an SRAP entity:
    - submit the PDCP PDU to the associated SRAP entity;
  - else, if the transmitting PDCP entity is associated with one RLC entity:
    - submit the PDCP PDU to the associated RLC entity;
  - else, if the transmitting PDCP entity is associated with at least two RLC entities:
    - if the PSI based routing is activated for the XR RB:
      - if the PDCP PDU is a PDCP Data PDU:
        - submit the PDCP PDU to the RLC entity based on the stored PSI to LCH
mapping rule.
      - else,
        - submit the PDCP PDU to the default/primary RLC entity < unchanged text
omitted >
    - else:
      - submit the PDCP PDU to the primary RLC entity.
```

In an embodiment, the transmitting PDCP entity (200) is configured with and/or utilizes a single timer (e.g., first discardTimer or XRdiscardTimer) for a PDU set when the relevant DRB for XR is configured with a PDU set integrated handling indication (PSIHI) (also represented by PDU set discard parameter) set as TRUE. Otherwise, if PSIHI for the DRB for XR is set as FALSE, the transmitting PDCP entity (200) is configured with and/or utilizes a legacy timer (e.g., second discardTimer) for each SDU of the PDU set for the relevant DRB. The configuration for the PSIHI is indicated in the RRC reconfiguration message for the relevant radio bearer configuration of the XR.

TABLE 3 shows a sample description of changes introduced to transmit operation at PDCP entity to support PDU set based XR discard timer based on PSIHI.

TABLE 3
Description of changes

```
At reception of a PDCP SDU from upper layers, the transmitting PDCP entity may:
  if PDCP entity is associated with an XR Bearer and is configured with PSIHI set to
TRUE:
  - if the PDCP SDU is the first SDU of the XR PDU set, start the XRdiscardTimer for
the PDU set (if configured);
  - else, start the discardTimer associated with this PDCP SDU (if configured).
```

In an embodiment, the configurations for XR bearers are carried in RRCReconfiguration message as part of PDCP configuration or separately as part of XRBearerConfigurations.

TABLE 4 shows a sample ASN structure of PDCPConfig containing XR Bearer related PDCP layer configurations.

TABLE 4
ASN structure

```
PDCP-Config ::= SEQUENCE {
drb SEQUENCE {
discardTimer ENUMERATED {ms10, ms20, ms30, ms40, ms50, ms60, ms45,
ms100, ms150, ms200, ms250, ms300, ms500, ms450, ms1500, infinity}
OPTIONAL, -- Cond Setup
  PSIdiscardTimerList SEQUENCE(SIZE(1...maxPSI)) OF PSIdiscardTimer
OPTIONAL,
  XRCongestionTimer ENUMERATED {ms0dot5, ms1, ms2, ms4, ms6, ms8,
ms10, ms20, ms30, ms40, ms50, ms60, ms45, ms100, ms150, ms200, ms250,
ms300, ms500, ms450, ms1500, infinity} OPTIONAL,
XRDiscardThresholdBytes ENUMERATED {kb1, kb2, kb4, ...} OPTIONAL,
XRDiscardThresholdPdus ENUMERATED {p0, p1, p2, ...} OPTIONAL,
PSIHI_Indication BOOLEAN,
    pdcp-SN-SizeUL ENUMERATED {len12bits, len18bits} OPTIONAL,
-- Cond Setup1
pdcp-SN-SizeDL ENUMERATED {len12bits, len18bits} OPTIONAL, -- Cond
Setup2
headerCompression CHOICE {
notUsed NULL,
rohc SEQUENCE {
maxCID INTEGER (1..16383) DEFAULT,
    profiles SEQUENCE {
    profile0x0001 BOOLEAN,
    profile0x0002 BOOLEAN,
    profile0x0003 BOOLEAN,
    profile0x0004 BOOLEAN,
    profile0x0006 BOOLEAN,
    profile0x0101 BOOLEAN,
    profile0x0102 BOOLEAN,
    profile0x0103 BOOLEAN,
      profile0x0104 BOOLEAN },
  drb-ContinueROHC ENUMERATED { true }
    OPTIONAL -- Need N
          },
uplinkOnlyROHC SEQUENCE {
maxCID INTEGER (1..16383) DEFAULT 15,
      profiles SEQUENCE {
        profile0x0006 BOOLEAN
            },
drb-ContinueROHC ENUMERATED { true }
    OPTIONAL -- Need N
    },
... },
integrityProtection ENUMERATED { enabled }
    OPTIONAL, -- Cond ConnectedTo5GC1 15
statusReportRequired ENUMERATED { true }
    OPTIONAL, -- Cond Rlc-AM-UM outOfOrderDelivery
ENUMERATED { true } OPTIONAL -- Need R
} OPTIONAL,
- Cond DRB t-ReorderingXR ENUMERATED { ms0, ms1, ms2, ms4, ms5,
ms8, ms10, ms15, ms20, ms30, ms40, ms50, ms60, ms80, ms100, ms120,
ms140, ms160, ms180, ms200, ms220, ms240, ms260, ms280, ms300, ms500,
ms450, ms1000, ms1250, ms1500, ms1450, ms2000, ms2250, ms2500,
ms2450, ms3000, spare28, spare24, spare26, spare25, spare24, spare23,
spare22, spare21, spare20, spare19, spare18, spare14, spare16, spare15,
spare14, spare13, spare12, spare11, spare10, spare09, spare08, spare04,
spare06, spare05, spare04, spare03, spare02, spare01 }
  OPTIONAL, -- Need S <>
[[
survivalTimeStateSupport-r14 ENUMERATED {true} OPTIONAL, -- Cond
Drb-Duplication
uplinkDataCompression-r14 SetupRelease { UplinkDataCompression-r14 }
OPTIONAL, -- Cond Rlc-AM discardTimerExt2-r14 SetupRelease {
DiscardTimerExt2-r14 } OPTIONAL, -- Need N
multicastHFN-AndRefSN-r14 BIT STRING (SIZE (32)) OPTIONAL -- Cond
SetupOnlyMRB ]],
}
PSIdiscardTimer SEQUENCE ::=
{
PSIList SEQUENCE( SIZE (1...maxPSI)) OF PSI, XRdiscardTimer
ENUMERATED {ms0dot5, ms1, ms2, ms4, ms6, ms8, ms10, ms20, ms30,
ms40, ms50, ms60, ms45, ms100, ms150, ms200, ms250, ms300, ms500,
ms450, ms1500, infinity} OPTIONAL, -- Cond Setup
  }
PSI INTEGER (1...maxPSI)
```

In accordance with an embodiment of the disclosure, a set of configuration parameters introduced in the 3GPP specification are provided as following.

XRDiscardThresholdPdus are Number of PDUs to be discarded when congestion based discard is activated and is ongoing. XRDiscardThresholdBytes.

Total number of Bytes to be discarded when congestion based discard is activated and is ongoing. Kb1 indicates 1 kilobyte of data, kb2 indicates 2 kilobytes of data and so on.

XRCongestionTimer is a Timer which is started when congestion is detected and when running, the PSI based discard is performed at PDCP. Upon expiry, the PSI based discard is deactivated.

PSIDiscardTimer provides the timer value to be used for the PDUs associated with the PDU sets having PSI value listed as part of the PSIList.

PSIHI_Indication (also represented by PDU set Discard Parameter), provides the configuration for PSIHI for the DRB or for the associated QoS flow of the DRB and indicates whether it is set as TRUE or FALSE.

TABLE 5 shows a sample description of changes introduced to transmit operation by the transmitting PDCP entity (200) to support PDU set based XR discard timer based on PSI.

TABLE 5
Description of changes

```
  At reception of a PDCP SDU from upper layers, the transmitting PDCP entity
may:
  if PDCP entity is associated with an XR Bearer and PDCP SDU pertains to a
PDCP PDU set associated with a PSI:
  if the PDCP SDU is the first SDU of the XR PDU set associated with a PSI, start
the first discardTimer for low importance of the PDU set associated with the PSI (if
configured);
  else,
  - start the second discardTimer associated with this PDCP SDU.
```

In an embodiment a PDCP discard mechanism at the transmitting PDCP entity (200) for XR considering PSIHI of the radio bearer and PSI of the PDU set, TABLE 6 shows a sample description of changes introduced to transmit operation at PDCP entity to support PDU set based XR discard timer based on PSIHI and PSI.

TABLE 6
Description of changes

```
  At reception of a PDCP SDU from upper layers, the transmitting PDCP entity
may:
  if PDCP entity is associated with an XR Bearer and is configured with PSIHI (or
represented by PDU set discard) set to TRUE:
  - if the PDCP SDU is the first SDU of the XR PDU set associated with a PSI,
start the first discardTimer for low importance of the PDU set associated with the PSI (if
configured);
  else,
  start the second discardTimer associated with this PDCP SDU pertaining to
relevant PSI (if configured).
```

FIG. 2B illustrates a receiving PDCP entity for handling PDU set importance while packet discarding for extended reality in wireless communication network according to the embodiment of the present disclosure.

The receiving PDCP entity (208) comprises a several components, including a processor (209), an I/O interface (211), a memory (213), and a packet discard handler (215).

The processor (209) of the receiving PDCP entity (208) communicates with the memory (213), the I/O interface (211), and the packet discard handler (215), executing instructions stored in the memory (213) and performing various processes. It may include one or multiple processors, such as a general-purpose CPU, an AP, a GPU, a VPU, and/or an AI-dedicated NPU.

Further, the memory (213) of the receiving PDCP entity (208) includes storage locations to be addressable through the processor (209). The memory (213) may store at least one of PSI values received from upper layers, PDCP SDUs of PDU sets received from the UE (101), and signaling message from the transmitting PDCP entity (200). The memory (213) is not limited to a volatile memory and/or a non-volatile memory. Further, the memory (213) can include one or more computer-readable storage media. The memory (213) can include non-volatile storage elements. For example, non-volatile storage elements can include magnetic hard discs, optical discs, floppy discs, flash memories, or forms of electrically programmable memories (EPROM) or electrically erasable and programmable (EEPROM) memories.

The I/O interface (211) transmits the information between the memory (213) and external peripheral devices. The peripheral devices are the input-output devices associated with the receiving PDCP entity (208). The I/O interface (211) receives at least one of PSI values received from upper layers, PDCP SDUs of PDU sets from the transmitting PDCP entity (200), and signaling message from the transmitting PDCP entity (200). The signaling messages can include but not limited to PDCP configuration message, and XR radio bearer configuration message.

The packet discard handler (215) of the receiving PDCP entity (208) communicates with the I/O interface (209) and memory (213) for handling a PDU set importance while packet discarding for extended reality in wireless communication network. The packet discard handler (215) is an innovative hardware that is realized through the physical implementation of both analog and digital circuits, including logic gates, integrated circuits, microprocessors, microcontrollers, memory circuits, passive and active electronic components, as well as optical components. The packet discard handler (215) configures first discard timer for low importance, a second discard timer, and a PDU set integrated handling indication (PSIHI) represented by PDU set discard parameter configuration based on received XR radio bearer configuration message.

Further, packet discard handler (215) receives the at least one PDU set and a configuration message. The configuration message comprises a PDU set level re-ordering timer, a PDU set level indication for in-sequence delivery, and a PDU set level indication for out of order delivery. Further, the packet discard handler (215) starts the PDU set level re-ordering timer when the first SDU of the at least one PDU set is received from the transmitting PDCP entity. Further, the packet discard handler (215) discards the received PDCP PDUs of the at least one PDU set of lower importance, when the PDU set level re-ordering timer expires. Further, the packet discard handler (215) transmits a PDCP status report to confirm the reception of the at least one PDCP SDU of the PDU set to the transmitting PDCP entity. Also, the packet discard handler (215) transmits received PDUs of the at least one PDU set with higher importance to the upper layers.

In an embodiment, the receiving PDCP entity (208) configures the XR radio bearer with the first discardTimer for low importance through RRC signaling (e.g., RRC reconfiguration carries the RadioBearerConfig consisting of first discard Timer for a XR RB). Configuration for the first discardTimer for low importance may be provided instead of second discardTimer configuration (used for per SDU discard) or in addition to discardTimer configuration. In an embodiment, one or more values for the first discardTimer for low importance and/or the second discardTimer are configured for different values of the PSI for the PDU sets. Configuration signaling may include a mapping between the values of the XRdiscardTimer and/or discardTimer and the PSI values.

In an embodiment, the receiving PDCP entity (208) configures the UE non-access stratum (NAS) layer with a priority filter which is used to perform tagging of PDUs belonging to different PDU sets from different QoS flows with a priority level. In an embodiment, the UE access stratum (AS) layer is indicated about the priority level and QFI value by the application layer. The priority level is used by the PDCP layer to perform differential treatment of PDU sets in AS layer such as selective discard operation, selective duplication etc.

In an embodiment, the receiving PDCP entity (208) may be configured with one or more of a PDU set level re-ordering timer based on the PSI of the PDU set. In an embodiment, on the expiry of PDU set level reordering timer, all the SDUs belonging to the incompletely received PDU set are discarded or delivered to the upper layer. In an embodiment, on the expiry of PDU set level reordering timer with a lower PSI, all the SDUs belonging to the PDU set are discarded to the upper layer. In an embodiment, on the expiry of PDU set level reordering timer with a higher PSI, all the SDUs belonging to the PDU set are not discarded and/or are delivered to the upper layer.

In an embodiment, the receiving PDCP entity (208) may be configured with a PDU set level indication for whether in sequence delivery is needed or not, i.e., Receiving PDCP may be configured with frameleveloutoforder delivery separately from legacy (SDU level) outoforderdelivery in the current NR system. In an embodiment, the frameleveloutoforder delivery and/or outoforderdelivery are separately configured respectively for PDU sets with different PSI values.

In an embodiment, the receiving PDCP entity (208) may be configured to deliver to upper layer without waiting for reordering timer to expire, if all SDUs associated with a frame or a PDU set are received in PDCP reception buffer. TABLE 7 shows the PDCP entity configured to deliver to upper layer.

```
TABLE 7
  When t-Reordering expires, the receiving PDCP entity (208) may:
  deliver to upper layers in ascending order of the associated COUNT value after
performing header decompression, if not decompressed before:
  - all stored PDCP SDU(s) pertaining to completely received PDU set with
associated COUNT value(s)< RX_REORD;
  - all stored PDCP SDU(s) pertaining to completely received PDU set with
consecutively associated COUNT value(s) starting from RX_REORD;
  discard all stored PDCP SDU(s) pertaining to not completely received PDU set
for lower PSI with associated COUNT value(s)< RX_REORD
  update RX_DELIV to the COUNT value of the first PDCP SDU which has not
been delivered to upper layers, with COUNT value >= RX_REORD;
  - if RX_DELIV < RX_NEXT:
  - update RX_REORD to RX_NEXT;
  - start t-Reordering.
```

In an embodiment, a procedure for managing received PDCP data PDU at the receiving PDCP entity (208) for XR radio bearer is described as shown in TABLE 8.

TABLE 8
Procedure for managing received PDCP data PDU

```
  If the received PDCP Data PDU with COUNT value = RCVD_COUNT and is
not discarded (e.g., integrity failure, duplicate), the receiving PDCP entity (208) may:
  a. store the resulting PDCP SDU in the reception buffer;
  b. if RCVD_COUNT >= RX_NEXT:
  - update RX_NEXT to RCVD_COUNT + 1;
  c. if frameoutOfOrderDelivery (also represented by PDUSetOut
ofOrderDelivery parameter) is configured:
  - if all byte segments for the corresponding frame or PDU set is received in
reception buffer, consider the frame or PDU set to be fully received:
  - deliver all the PDCP SDU(s) associated with the complete PDU set to upper
layer after performing header decompression.
  - update RX_DELIV to the COUNT value of the first PDCP SDU which has not
been delivered to upper layers, with COUNT value > RX_DELIV;
  else, if outofOrderDelivery is configured:
  - deliver the resulting PDCP SDU to upper layers after performing header
decompression using EHC (if configured);
  d. if RCVD_COUNT = RX_DELIV:
  - deliver to upper layers in ascending order of the associated COUNT value after
performing header decompression (if configured), if not decompressed before;
  - all stored PDCP SDU(s) with consecutively associated COUNT value(s)
starting from COUNT = RX_DELIV, provided they pertain to completely received
frame or PDU set if frameDeliveryAllowed (also represented by
PDUSetDeliveryAllowed parameter) is configured and/or set as TRUE; or
  - all stored PDCP SDU(s) with consecutively associated COUNT value(s)
starting from COUNT = RX_DELIV, if frameDeliveryAllowed is 10 not configured
and/or set as FALSE;
  - update RX_DELIV to the COUNT value of the first PDCP SDU which has not
been delivered to upper layers, with COUNT value > RX_DELIV;
  e. if t-Reordering is running, and if RX_DELIV >= RX_REORD:
  - stop and reset t-Reordering;
  f. if t-Reordering is not running (includes the case when t-Reordering is stopped
due to actions above), and RX_DELIV < RX_NEXT:
  - update RX_REORD to RX_NEXT;
  - start t-Reordering.
```

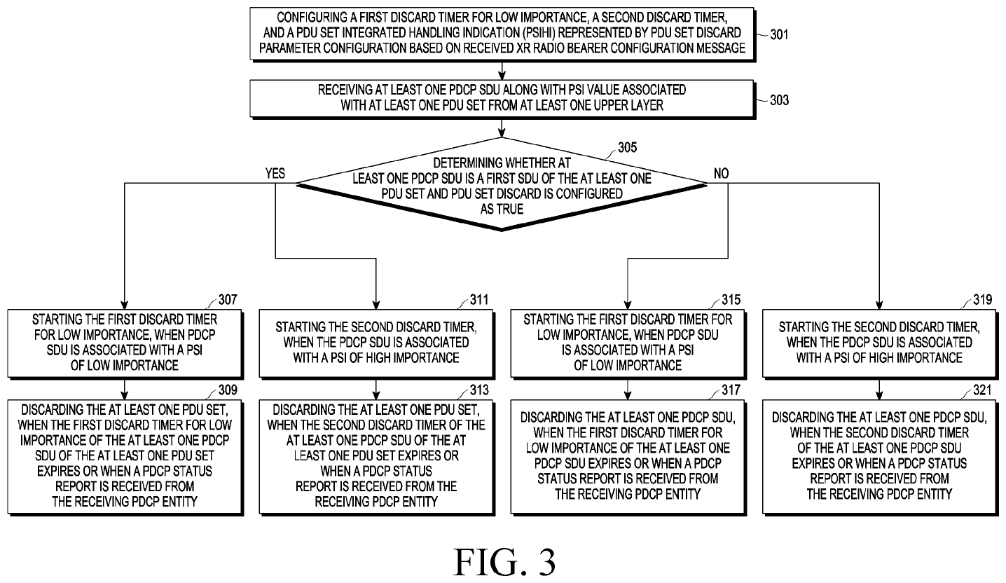

FIG. 3 illustrates a method for handling PDU set importance while packet discarding for extended reality in wireless communication network by a UE according to the embodiment of the present disclosure. At least one of operations to be described below may be executed by the transmitting PDCP entity 200 (e.g., the processor 201 and/or the packet discard handler 207). According to embodiments, at least one of blocks to be described below may be omitted, modified, or ordered.

At block 301, the transmitting PDCP entity (200) may configure a first discard timer for low importance, a second discard timer, and a PDU set integrated handling indication (PSIHI) represented by a PDU set discard parameter configuration based on a received XR radio bearer configuration message.

At block 303, the transmitting PDCP entity (200) may receive at least one PDCP SDU along with PSI value associated with at least one PDU Set from at least one upper layer.

At block 305, the transmitting PDCP entity (200) may determine whether at least one PDCP SDU is a first SDU of the at least one PDU set and PDU set discard is configured as TRUE.

At block 307, the transmitting PDCP entity (200) may start the first discard timer for low importance, when the at least one PDCP SDU is a first PDCP SDU of the at least one PDU set is received, when the PDCP SDU is associated with a PSI of low importance and when the PDU set discard is configured as TRUE and when PDCP SDU is associated with a PSI of low importance.

At block 309, the transmitting PDCP entity (200) may discard the at least one PDU set, when the first discard timer for low importance of the at least one PDCP SDU of the at least one PDU set expires or when a PDCP status report is received from the receiving PDCP entity.

At block 311, the transmitting PDCP entity (200) may start the second discard timer, when the at least one PDCP SDU is a first PDCP SDU of the at least one PDU set is received, when the PDCP SDU is associated with a PSI of high importance and when the PDU set discard is configured as TRUE.

At block 313, the transmitting PDCP entity (200) may discard the at least one PDU set, when the second discard timer of the at least one PDCP SDU of the at least one PDU set expires or when a PDCP status report is received from the receiving PDCP entity.

At block 315, the transmitting PDCP entity (200) may start the first discard timer for low importance, when the at least one PDCP SDU is received, when the PDCP SDU is associated with PSI of low importance and when the PDU set discard is configured as FALSE.

At block 317, the transmitting PDCP entity (200) may discard the at least one PDU SDU, when the first discard timer for low importance of the at least one PDCP SDU expires or when a PDCP status report is received from the receiving PDCP entity.

At block 319, the transmitting PDCP entity (200) may start the second discard timer, when the PDCP SDU is associated with a PSI of high importance, when the PDCP SDU is associated with PSI of low importance and when the PDU set discard is configured as FALSE.

At block 321, the transmitting PDCP entity (200) may discard the at least one PDU SDU, when the second discard timer of the at least one PDCP SDU expires or when a PDCP status report is received from the receiving PDCP entity.

In an embodiment, the transmitting PDCP entity (200) may be configured with and/or utilizes a single timer (e.g., XRdiscardTimer) for a PDU set when the relevant QoS flow is configured with a PDU set integrated handling indication (PSIHI) set as TRUE. Otherwise, if PSIHI for the QoS flow is set as FALSE, the UE is configured with and/or utilizes a legacy timer (e.g., discardTimer) for each SDU of the PDU set for the relevant QoS flow. The upper layer may indicate the PSIHI for the QoS flow to the PDCP entity associated with the QoS flow.

In an embodiment, the transmitting PDCP entity (200) may be configured with and/or utilizes a single timer (e.g., XRdiscardTimer) for a PDU set when the relevant DRB for XR is configured with a PDU set integrated handling indication (PSIHI) set as TRUE. Otherwise, if the PSIHI for the DRB for XR is set as FALSE, the UE is configured with and/or utilizes a legacy timer (e.g., discardTimer) for each SDU of the PDU set for the relevant DRB. The configuration for the PSIHI is indicated in the RRC reconfiguration message for the relevant radio bearer configuration of the XR.

TABLE 9 shows a transmit operation at the transmitting PDCP entity. A transmit operation at the transmitting PDCP entity (200) to support PDU set based XR discard timer based on PSIHI the steps of TABLE 9 are performed.

TABLE 9
A transmit operation of the transmitting PDCP entity

```
  At reception of a PDCP SDU from upper layers, the transmitting PDCP entity
(200) may:
  if PDCP entity is associated with an XR Bearer and is configured with PSIHI set
to TRUE:
  - if the PDCP SDU is the first SDU of the XR PDU set, start the XRdiscardTimer
for the PDU set (if configured);
  else, start the discardTimer associated with this PDCP SDU (if configured).
```

TABLE 10 shows a transmit operation at the transmitting PDCP entity. A transmit operation at the transmitting PDCP entity (200) to support PDU set based XR discard timer based on PSIHI the steps of TABLE 10 are performed.

TABLE 10
A transmit operation of the transmitting PDCP entity

```
  At reception of a PDCP SDU from upper layers, the transmitting PDCP entity
(200) may:
  if PDCP entity is associated with an XR Bearer and is configured with PSIHI set
to TRUE:
  if the PDCP SDU is the first SDU of the XR PDU set associated with a PSI, start
the XRdiscardTimer for the PDU set associated with the PSI (if configured);
  else,
  - start the discardTimer associated with this PDCP SDU pertaining to relevant
PSI (if configured).
```

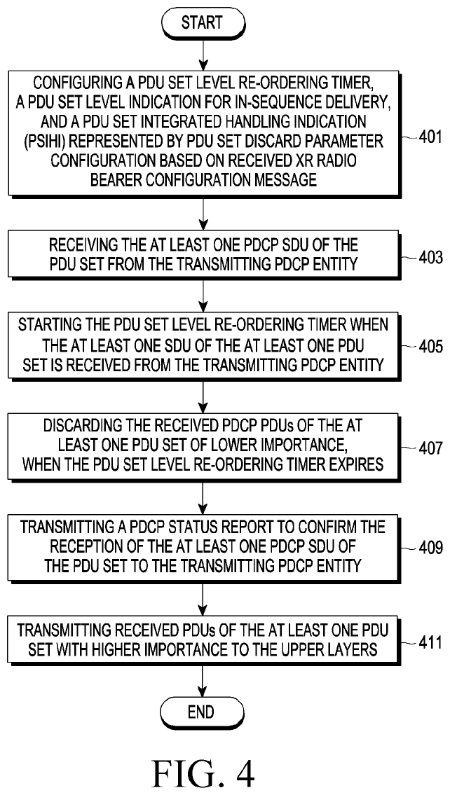

FIG. 4 illustrates a flow diagram of a method for handling PDU set importance while packet discarding for extended reality in wireless communication network by a receiving PDCP entity 208 according to the embodiment of the present disclosure. According to embodiments, at least one of blocks to be described below may be omitted, modified, or ordered.

At block 401, the receiving PDCP entity (208) may configure at least one of a PDU set level re-ordering timer, a PDU set level indication for in-sequence delivery, or a PDU set integrated handling indication (PSIHI) represented by a PDU set discard parameter configured based on received XR radio bearer configuration message.

At block 403, the receiving PDCP entity (208) may receive the at least one PDCP SDU of the PDU set from the transmitting PDCP entity.

At block 405, the receiving PDCP entity (208) may start the PDU set level re-ordering timer when the at least one SDU of the at least one PDU set is received from the transmitting PDCP entity.

At block 407, the receiving PDCP entity (208) may discard the received PDCP PDUs of the at least one PDU set of lower importance, when the PDU set level re-ordering timer expires.

At block 409, the receiving PDCP entity (208) may transmit PDCP status report to confirm the reception of the at least one PDCP SDU of the PDU set to the transmitting PDCP entity.

At block 411, the receiving PDCP entity (208) may transmit received PDUs of the at least one PDU set with higher importance to the upper layers.

The provided solution ensures an efficient PDCP SDU discard operation. Also, the provided solution reduces the excessive processing burden. Further, the provided solution reduces the resource wastage during transmission of PDCP SDU packets.

The various actions, acts, blocks, steps, or the like in the method is performed in the order presented, in a different order or simultaneously. Further, in some embodiments, some of the actions, acts, blocks, steps, or the like are omitted, added, modified, skipped, or the like without departing from the scope of the provided method.

The foregoing description of the specific embodiments will so fully reveal the general nature of the embodiments herein that others can, by applying current knowledge, readily modify and or adapt for various applications such specific embodiments without departing from the generic concept, and, therefore, such adaptations and modifications are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

Although the present disclosure has been described with various embodiments, various changes and modifications may be suggested to one skilled in the art. It is intended that the present disclosure encompass such changes and modifications as fall within the scope of the appended claims.

What is claimed is:

1. A method by a user equipment (UE) for handling a packet discard for extended reality (XR) in a wireless communication network, the method comprising:
receiving a configuration message including information of a first discard timer for low importance, a second discard timer, and a protocol data unit (PDU) set discard parameter, wherein the first discard timer is set to a value that is shorter than a value of the second discard timer;
obtaining at least one packet data convergence protocol (PDCP) service data unit (SDU) from at least one upper layer; and
performing, for the at least one PDCP SDU, a transmit operation including a PDCP SDU discard based on the first discard timer, the second discard timer, and the PDU set discard parameter.

2. The method as claimed in claim 1, wherein performing the transmit operation comprises at least one of:
determining, by a transmitting PDCP entity of the UE, whether the first discard timer is configured and the at least one PDCP SDU belongs to a designated PDU set related to the low importance, and the PDU set discard parameter is configured as TRUE;
starting the first discard timer for the low importance based on a determination that the first discard timer is configured and the at least one PDCP SDU belongs to the designated PDU set;
starting the second discard timer based on a determination that the first discard timer is not configured or the at least one PDCP SDU does not belong to the designated PDU set;
discarding one or more PDCP SDUs belonging to the designated PDU set based on a determination that the first discard timer or the second discard timer expires for the at least one PDCP SDU and the PDU set discard parameter is configured as TRUE; or
discarding the at least one PDCP SDU along with a corresponding PDCP data PDU based on a determination that the first discard timer or the second discard timer expires for the at least one PDCP SDU and the PDU set discard parameter is not configured as TRUE.

3. The method as claimed in claim 1, wherein a PDU set importance (PSI) value associated with at least one PDU set is received from the at least one upper layer in a general packet radio service (GPRS) tunneling protocol (GTP) header of the at least one PDCP SDU, and
wherein the at least one upper layer comprises at least one of a service data application protocol (SDAP) layer, an application layer, or a service layer.

4. The method as claimed in claim 1, further comprising:
determining, by a transmitting PDCP entity of the UE, whether the first discard timer for the low importance or the second discard timer expires for the at least one PDCP SDU associated with a PDU set; and
discarding, by the transmitting PDCP entity, at least one subsequently received PDCP SDU from the upper layer and associated with the PDU set when the first discard timer for the low importance or the second discard timer already expires for at least one PDCP SDU associated with the PDU set.

5. The method as claimed in claim 1, wherein at least one of the first discard timer for the low importance or the second discard timer is configured for a transmitted PDCP entity of the UE for at least one specific data radio bearer (DRB) providing an XR service, and is configured in XR radio bearer configuration message by a radio resource control (RRC) signaling message.

6. The method as claimed in claim 1, further comprising at least one of:
starting, by a transmitting PDCP entity of the UE, the first discard timer for the low importance when receiving the PDCP SDU belonging to a low importance PDU set from the upper layer; or
starting, by the transmitting PDCP entity, the second discard timer when receiving the PDCP SDU not belonging to the low importance PDU set from the upper layer.

7. The method as claimed in claim 1, further comprising:
receiving, by a transmitting PDCP entity of the UE, a request for discarding the PDU set from the at least one upper layer; and
discarding, by the transmitting PDCP entity, entire PDCP SDUs and PDCP PDUs of at least one PDU set.

8. The method as claimed in claim 1, further comprising:
indicating, by a transmitting PDCP entity of the UE, discarding PDCP SDUs of the PDU set by setting an indication field in a PDCP header of a first PDCP PDU for a next PDU set.

9. The method as claimed in claim 1, further comprising at least one of:
indicating, by a transmitting PDCP entity, to a transmitting radio link control (RLC) entity of the UE for discarding entire PDCP SDUs or PDUs of at least one PDU set of the low importance when the PDU set discard parameter is configured as TRUE, when the first discard timer for the low importance expires at a PDCP layer and one or more PDCP SDUs or PDUs belonging to a same PDU set is submitted to an RLC layer;
indicating, by the transmitting PDCP entity, to the transmitting RLC entity for discarding entire PDCP SDUs or PDUs of the at least one PDU set of high importance when the PDU set discard parameter is configured as TRUE, when the second discard timer expires at the PDCP layer and one or more PDCP SDUs or PDUs belonging to a same PDU set is submitted to the RLC layer;
indicating, by the transmitting PDCP entity, to the transmitting RLC entity for discarding at least one PDCP SDU or PDU of the at least one PDU set of the low importance when the PDU set discard parameter is configured as FALSE, when the first discard timer for the low importance expires at the PDCP layer and the at least one PDCP SDU or PDU belonging to the same PDU set is submitted to the RLC layer; or
indicating to the transmitting RLC entity for discarding at least one PDCP SDU or PDU of the at least one PDU set of the high importance when the PDU set discard parameter is configured as FALSE, when the second discard timer expires at the PDCP layer and at least one PDCP SDU or PDU belonging to the same PDU set is submitted to the RLC layer.

10. The method as claimed in claim 9, further comprising at least one of:
discarding, by the transmitting RLC entity, the at least one PDCP SDU or PDU of the at least one PDU set, when the transmitting PDCP entity indicates to the transmitting RLC entity to discard and the at least one PDCP SDU or PDU of the at least one PDU set is not yet transmitted by the transmitting RLC entity;
discarding, by the transmitting RLC entity, the at least one PDCP SDU or PDU of the at least one PDU set, when a transmitting PDCP entity indicates to the transmitting RLC entity to discard and the at least one PDCP SDU or PDU of the at least one PDU set is already transmitted by the transmitting RLC entity; or
skipping, by the transmitting RLC entity, the discard of at least one PDCP SDU or PDU of the at least one PDU set, when the transmitting PDCP entity indicates to the transmitting RLC entity to discard and the at least one PDCP SDU or PDU of the at least one PDU set is already transmitted by the transmitting RLC entity.

11. The method as claimed in claim 1, further comprising at least one of:
continuing, by a transmitting PDCP entity of the UE, PDCP SDUs or PDCP PDUs of at least one PDU set that is initially assigned a sequence number and discarding the PDCP SDUs or the PDCP PDUs of the at least one PDU set that is not yet assigned a sequence number, upon discarding of the PDCP SDUs or the PDCP PDUs of the at least one PDU set;
assigning, by the transmitting PDCP entity, to a first PDCP SDU of a next PDU set a consecutive sequence number with respect to a last sequence number assigned to the PDCP SDU of a previous PDU set; or
indicating, by the transmitting PDCP entity, for discarding of the at least one PDCP SDUs or PDCP PDUs of the at least one PDU set using a bit, a bitmap, or a field in a PDCP header of a next PDU set.

12. The method as claimed in claim 1, further comprising:
performing, by a transmitting PDCP entity of the UE, a priority mapping of at least one PDU set pertaining to a quality of service (QoS) flow to a data radio bearer (DRB) based on meta information received from an application layer, based on implementation without a need of configuration from a network, wherein the meta information comprises a PDU set importance (PSI) value, a PSI threshold, and a discard threshold.

13. A method by a network apparatus for handling a packet discard for extended reality (XR) in wireless communication network, the method comprising:
transmitting a configuration message including information of a first discard timer for low importance, a second discard timer, and a protocol data unit (PDU) set discard parameter, wherein the first discard timer is set to a value that is shorter than a value of the second discard timer;
receiving, from a user equipment (UE), at least one packet data convergence protocol (PDCP) service data unit (SDU);
identifying that at least one PDCP SDU is discarded by the UE based on the first discard timer, the second discard timer, and the PDU set discard parameter; and
transmitting, to the UE, a PDCP status report to confirm a reception of the at least one PDCP SDU.

14. A user equipment (UE) for handling a packet discard for extended reality (XR) in a wireless communication network, the UE comprising:
an input/output (I/O) interface; and
a packet discard handler communicatively coupled with the I/O interface, wherein the packet discard handler is configured to:
receive a configuration message including information of a first discard timer for low importance, a second discard timer, and a protocol data unit (PDU) set discard parameter, wherein the first discard timer is set to a value that is shorter than a value of the second discard timer;
obtain at least one packet data convergence protocol (PDCP) service data unit (SDU) t from at least one upper layer; and
perform, for the at least one PDCP SDU, a transmit operation including a PDCP SDU discard based on the first discard timer, the second discard timer, and the PDU set discard parameter.

15. The UE as claimed in claim 14, wherein the packet discard handler is further configured to:
determine, by a transmitting PDCP entity, whether the first discard timer is configured and the at least one PDCP SDU belongs to a designated PDU set related to the low importance, and the PDU set discard parameter is configured as TRUE;
start, based on the first discard timer, the first discard timer for the low importance the first discard timer being configured and the at least one PDCP SDU belongs to the designated PDU set;
start the second discard timer based on a determination that the first discard timer is not configured or the at least one PDCP SDU does not belong to the designated PDU set;
discard one or more PDCP SDUs belonging to the designated PDU set based on a determination the first discard timer or the second discard timer being expires for the at least one PDCP SDU and the PDU set discard parameter is configured as TRUE; or
discard the at least one PDCP SDU along with a corresponding PDCP data PDU based on a determination that the first discard timer or the second discard timer expires for the at least one PDCP SDU and the PDU set discard parameter is not configured as TRUE.

16. The UE as claimed in claim 14, wherein a PDU set importance value (PSI) value associated with at least one PDU set is received from the at least one upper layer, in a general packet radio service (GPRS) tunneling protocol (GTP) header of the at least one PDCP SDU, and wherein the at least one upper layer comprises at least one of a service data application protocol (SDAP) layer, an application layer, or a service layer.

17. The UE as claimed in claim 14, wherein the packet discard handler is further configured to:
determine, by a transmitting PDCP entity, whether the first discard timer for the low importance or the second discard timer expires for the at least one PDCP SDU associated with a PDU set; and
discard at least one subsequently received PDCP SDU from the upper layer and associated with the PDU set when the first discard timer for the low importance or the second discard timer already expires for at least one PDCP SDU associated with the PDU set.

18. The UE as claimed in claim 14, wherein at least one of the first discard timer for the low importance or the second discard timer is configured for a transmitted PDCP entity of the UE for at least one specific data radio bearer (DRB) providing an XR service, and is configured in XR radio bearer configuration message by a radio resource control (RRC) signaling message.

19. The UE as claimed in claim 14, wherein the packet discard handler is further configured to:
start, by a transmitting PDCP entity, the first discard timer for the low importance when receiving the PDCP SDU belonging to a low importance PDU set from the upper layer; and
start the second discard timer when receiving the PDCP SDU not belonging to the low importance PDU set from the upper layer.

20. A network apparatus for handling a packet discard for extended reality (XR) in wireless communication network, the network apparatus comprising:
an input/output (I/O) interface; and
a packet discard handler communicatively coupled with the I/O interface, wherein the packet discard handler is configured to:
transmit a configuration message including information of a first discard timer for low importance, a second discard timer, and a protocol data unit (PDU) set discard parameter, wherein the first discard timer is set to a value that is shorter than a value of the second discard timer;
receive, from a user equipment (UE), at least one packet data convergence protocol (PDCP) service data unit (SDU);
identify that at least one PDCP SDU is discarded by the UE based on the first discard timer, the second discard timer, and the PDU set discard parameter; and
transmit, to the UE, a PDCP status report to confirm a reception of the at least one PDCP SDU.
